(19) United States
(12) Patent Application Publication
(10) Pub. No.: US 2026/0091442 A1
(43) Pub. Date: Apr. 2, 2026

(54) COMPONENT SUCH AS A WEARING PART FOR AN ARC TORCH, IN PARTICULAR A PLASMA BURNER OR PLASMA CUTTING TORCH, ARC TORCH COMPRISING SAME, AND METHOD OF PLASMA CUTTING

(71) Applicant: Kjellberg-Stiftung, Finsterwalde (DE)

(72) Inventors: Roland RICHTER, Massen (DE); Frank LAURISCH, Finsterwalde (DE); Volker KRINK, Finsterwalde (DE)

(73) Assignee: Kjellberg-Stiftung, Finsterwalde (DE)

(21) Appl. No.: 19/113,399

(22) PCT Filed: Sep. 1, 2023
(86) PCT No.: PCT/EP2023/074033

§ 371 Date: Mar. 19, 2025

(30) Foreign Application Priority Data
Sep. 26, 2022 (DE) 10 2022 124 641.8

(51) Int. Cl. B23K 9/24; B23K 9/16; B23K 9/32; B23K 10/00; B23K 37/003

(52) U.S. Cl. CPC B23K 9/24; B23K 9/16; B23K 9/322; B23K 10/00; B23K 37/003

(57) ABSTRACT

Component for an electrically operated arc torch, in particular a plasma torch or plasma cutting torch, characterized in that the component or at least part or a region of the component consists of a material comprising aluminum oxide and at least one of the chemical elements silver and copper.

The present invention relates to a component, for example a mount and a holder for wearing parts, and to a wearing part, such as an electrode, a nozzle, a nozzle cap and a nozzle protection cap, for an arc torch, in particular a plasma torch or a plasma cutting torch, to an arc torch, in particular a plasma torch or a plasma cutting torch, having the same, and to a plasma cutting method.

Arc torches and plasma torches (plasma arc torches) in particular are typically used for thermal processing of a wide variety of different materials, such as metallic and non-metallic materials, for example for cutting, welding, labelling or quite generally for heating.

For example, a TIG torch may be an arc torch. However, it does not have a nozzle like a plasma torch. Nevertheless, the electrodes of an arc torch and a plasma torch may be identical.

Plasma torches typically consist essentially of a torch body, an electrode, a nozzle and a mount therefor. Modern plasma torches additionally have a nozzle protection cap mounted above the nozzle. A nozzle is often fixed by means of a nozzle cap.

The components that wear out through operation of the plasma torch as a result of the high thermal stress caused by the arc, depending on the type of plasma torch, are in particular the electrode, the nozzle, the nozzle cap, the nozzle protection cap, the nozzle protection cap mount and the plasma gas guide parts and secondary gas guide parts. These components can be easily replaced by an operator and can therefore be referred to as wearing parts (parts with limited service life).

The plasma torches are connected via wires to a power source and a gas supply that supply the plasma torch. Furthermore, the plasma torch may be connected to a cooling device for a cooling medium, for example a cooling fluid.

High thermal loads occur particularly in plasma cutting torches. The reason for this is the significant constriction of the plasma jet through the nozzle bore. Small bores are used here to produce high current densities of 50 to 150 A/mm² in the nozzle bore, high energy densities of about 2×10⁶ W/cm² and high temperatures of up to 30 000 K. Furthermore, higher gas pressures, generally up to 12 bar, are used in the plasma cutting torch. The combination of high temperature and high kinetic energy of the plasma gas flowing through the nozzle bore leads to melting of the workpiece and expulsion of the melt. A kerf is formed, and the workpiece is separated. Plasma cutting often involves using oxidizing gases to cut unalloyed or low-alloyed steels, and nonoxidizing gases to cut high-alloyed steels or nonferrous metals.

A plasma gas flows between the electrode and the nozzle. The plasma gas is guided by a gas guide part. This allows the plasma gas to be specifically directed. It is often displaced by a radial and/or axial offset of the openings in the plasma gas guide part in rotation about the electrode. The plasma gas guide part consists of electrically insulating material because the electrode and nozzle have to be electrically insulated from each other. This is necessary since the electrode and the nozzle have different electrical potentials during the operation of the plasma cutting torch. For the operation of the plasma cutting torch, an arc is generated between the electrode and the nozzle and/or the workpiece and ionizes the plasma gas. In order to ignite the arc, a high voltage can be applied between the electrode and the nozzle, which ensures preionization of the gap between the electrode and the nozzle and hence the formation of an arc. The arc that burns between electrode and nozzle is also referred to as pilot arc.

The pilot arc exits through the nozzle bore and hits the workpiece and ionizes the gap to the workpiece. This can result in formation of the arc between the electrode and the workpiece. This arc is also referred to as the main arc. During the main arc, the pilot arc can be switched off. However, it can also continue to operate. During plasma cutting, it is often switched off in order not to additionally stress the nozzle.

In particular, the electrode and the nozzle are subjected to high thermal stress and have to be cooled. At the same time, they must also conduct the electrical current required to form the arc. For that reason, materials of good thermal and electrical conductivity are used, generally metals, for example copper, silver, aluminum, tin, zinc, iron or alloys including at least one of these metals.

The electrode often consists of an electrode mount and an emission insert composed of a material having a high melting temperature (>2000° C.) and a lower electron work function than the electrode mount. Materials used for the emission insert are tungsten when nonoxidizing plasma gases are used, for example argon, hydrogen, nitrogen, helium and mixtures thereof, and hafnium or zirconium when oxidizing gases are used, for example oxygen, air and mixtures thereof, nitrogen-oxygen mixture and mixtures with other gases. The high-temperature material can be fitted into an electrode mount consisting of material of good and electrical conductivity, for example in a form-and/or force-fitting manner.

The electrode and nozzle can be cooled by gas, for example the plasma gas or a secondary gas that flows along the outside of the nozzle. However, a more effective method is cooling with a liquid, for example water. The electrode and/or nozzle are often cooled directly with the liquid, i.e. the liquid is in direct contact with the electrode and/or nozzle. In order to guide the coolant around the nozzle, there is a nozzle cap around the nozzle, the inner face of which forms a coolant space with the outer face of the nozzle, within which the coolant flows.

In modern plasma cutting torches, there is additionally a nozzle protection cap outside the nozzle and/or the nozzle cap. The inner face of the nozzle protection cap and the outer face of the nozzle or nozzle cap form a space through which a secondary gas or protective gas flows. The secondary gas or protective gas exits from the bore of the nozzle protection cap and surrounds the plasma jet and creates a defined atmosphere around it. In addition, the secondary gas protects the nozzle and the nozzle protection cap against arcs that can form between it and the workpiece. These are called double arcs and can cause damage to the nozzle. Especially in the case of piercing into the workpiece, the nozzle and the nozzle protection cap are subjected to severe stress by hot spattering of material. The secondary gas, the volume flow rate of which during piercing may be increased compared to the value during cutting, keeps the spattering material away from the nozzle and the nozzle protection cap, hence protecting them from damage.

The nozzle protection cap is likewise subject to high thermal stress and has to be cooled. For that reason, materials of good thermal and electrical conductivity are used, generally metals, for example copper, silver, aluminum, tin, zinc, iron or alloys including at least one of these metals.

The electrode and nozzle can also be cooled indirectly. They are in touch contact here with a component made from a material of good thermal and electrical conductivity, generally a metal, for example copper, silver, aluminum, tin, zinc, iron or alloys including at least one of these metals. This component is cooled directly in turn, meaning that it is in direct contact with the usually flowing coolant. These components can simultaneously serve as a mount or holder for the electrode, the nozzle, the nozzle cap or the nozzle protection cap, to dissipate heat and to supply power.

There is also the possibility that only the electrode or only the nozzle are cooled with liquid.

The nozzle protection cap is usually cooled only by the secondary gas. There are also known arrangements in which the secondary gas cap is cooled directly or indirectly by a cooling fluid.

In plasma torches, and in particular in plasma cutting torches, a high load on the wearing parts occurs because of the high energy density and the high temperatures. This particularly affects the electrode, the nozzle and the nozzle protection cap.

The use of solutions known to date for the electrode, the emission insert composed of high-melting material, for example tungsten, hafnium, in a material of good thermal conductivity, for example copper or silver, often does not achieve adequate results. Particularly in the case of large electrical currents, for example greater than 300 A, and in the case of the use of oxygen-containing gases or gas mixtures as plasma gases, service lives are often too short. There are often additionally large fluctuations in service life. The emission insert wears out during operation, i.e. during burning of the light arc or plasma jet. It gradually burns back. If it has burnt back by more than 1 mm, the use of copper as material for the electrode mount often leads to abrupt failure of the entire electrode. The arc or plasma jet then passes over from the emission insert to the holder and destroys it. This also destroys the nozzle. It is even possible for the whole torch to be destroyed.

When copper is used as material for the electrode mount, the electrode can burn back up to a maximum of 1 mm before failure.

Through use of silver as material for the electrode mount, the electrode can often burn back to 1.5 mm before failure.

Since this failure too occurs suddenly, the cutting process is abruptly ended in the cases described. It is often the case that the material to be cut is then unusable.

Especially when oxygen-rich secondary gas is used, i.e. the proportion of oxygen is at least 25 per cent by volume of the secondary gas, there can be formation of arcs, called double arcs, which burn between the nozzle, the protection cap and the workpiece.

Oxygen-rich secondary gas has a positive effect on the cutting quality of the workpiece to be cut, especially when cutting structural steels, with reduction of burr material and smoother cut surfaces. It is often possible to cut at higher speed compared to a secondary gas without oxygen or with a lower oxygen content.

It is also the case especially when argon-rich secondary gas is used, i.e. the proportion of argon is at least 25 per cent by volume of the secondary gas, that there can be formation of arcs, called double arcs, which burn between the nozzle, the protection cap and the workpiece.

Argon-rich secondary gas has a positive influence on the cutting quality of the workpiece to be cut, especially when cutting high-alloy steels, since the oxygen present in the ambient air is kept away from the cutting edges, and so a reaction, for example oxidation of these gases, with the hot plasma-cut surface of the workpiece is avoided.

The described double arcs damage the nozzle, the nozzle cap and the nozzle protection cap.

The aim of the invention is to improve the service life of components, for example mounts and holders for wearing parts, and of wearing parts, for example electrodes, nozzles, nozzle caps and nozzle protection caps, for an arc torch, in particular a plasma torch or a plasma cutting torch.

This object is achieved in accordance with the invention, in a first aspect, by a component for an electrically operated arc torch, in particular a plasma torch or plasma cutting torch, characterized in that the component or at least part or a region of the component consists of a material comprising aluminum oxide and at least one of the chemical elements silver and copper.

In addition, this object is achieved by an arc torch having at least one component as claimed in any of claims 1 to 23.

This object is also achieved by a method of plasma cutting using an arc torch, wherein the plasma cutting torch is operated with oxygen, an oxygen-containing gas or gas mixture and/or reducing gas or gas mixture and/or inert gas or gas mixture as plasma gas (PG) and/or secondary gas (SG).

Furthermore, this object is achieved by a method of plasma cutting using an arc torch, wherein the plasma cutting torch is operated with oxygen or an acidic gas mixture in which the proportion of oxygen is at least 25 per cent by volume of the gas mixture as plasma gas (PG) and/or secondary gas (SG).

Moreover, this object is achieved by a method of plasma cutting using a plasma cutting torch, wherein the plasma cutting torch is operated with argon or an argon-containing gas mixture in which the proportion of the argon is at least 25 percent by volume of the gas mixture as plasma gas (PG) and/or secondary gas (SG).

With regard to the component, at least one component or at least one of the components may be cooled with a liquid medium.

Alternatively, it may be the case that the proportion of aluminum oxide is not less than 0.15%, better not less than 0.3%, at best not less than 0.5%, of the volume or mass of the material.

Appropriately, the proportion of aluminum oxide is not more than 2.0%, better not more than 1.5%, at best not more than 1.0%, of the volume or mass of the material.

In a particular embodiment, the component is a wearing part for an arc torch.

In particular, the wearing part may be an electrode for an arc torch.

In a further particular embodiment, the electrode has a front end and a back end, extends along a longitudinal axis M and has at least one emission insert at the front end and an electrode mount and optionally a mount element for the emission insert.

In particular, it may be the case that at least a portion of an inner face of the electrode mount or an inner face of the mount element which is in touch contact with the emission insert consists of said material.

It may also be the case that the material extends radially outward by at least 0.5 mm, preferably at least 1 mm and at best at least 1.3 mm at least from the portion of the inner face of the electrode mount or the inner face of the mount element.

Advantageously, at least a portion of a front face directly adjacent to the front face of the emission insert comprises said material.

In particular, it may be the case that said portion of the front face extends radially outward by at least 0.5 mm, better at least 1 mm and at best at least 1.3 mm.

Advantageously, the emission insert consists at least to an extent of 90% of the volume or mass of hafnium or zirconium or tungsten.

In a further particular embodiment, it may be the case that the wearing part is a nozzle having at least one nozzle opening.

In particular, it may be the case that at least a portion of an inner face of the nozzle opening includes said material.

Favourably, the material extends radially outward at least from the portion of the inner face of the nozzle opening by at least 0.5 mm, better at least 1 mm and at best at least 1.3 mm.

In a further particular embodiment of the present invention, it may be the case that the wearing part is a nozzle protection cap having at least one nozzle protection cap opening.

Advantageously, at least a portion of an inner face of the nozzle protection cap opening includes said material.

Advantageously, the material extends radially outward at least from the portion of the inner face of the nozzle protection cap opening by at least 0.5 mm, better at least 1 mm and at best at least 1.3 mm.

In a further particular embodiment, it may be the case that the wearing part is a nozzle cap having at least one nozzle cap opening.

Advantageously, at least a portion of an inner face of the nozzle cap opening includes said material.

In particular, it may be the case that the material extends radially outward at least from the portion of the inner face of the nozzle cap opening by at least 0.5 mm, better at least 1 mm and at best at least 1.3 mm.

In a further particular embodiment, it may be the case that the component is a holder or mount for at least one wearing part for an arc torch.

In particular, it may be the case that the holder or mount is a nozzle holder, a nozzle cap holder or an electrode holder or a nozzle protection cap holder.

In a particular embodiment, the arc torch may be a plasma torch or plasma cutting torch.

Finally, in the method, it may be the case that the at least one component or at least one of the components is cooled with a liquid medium. The invention extends the service life of the components, for example wearing parts, in particular the electrode, of the arc torch, plasma torch and plasma cutting torch. The emission insert can further burn back to more than about 2 mm without destroying the electrode.

In particular, the service life of electrodes, nozzles and nozzle protection caps and their mounts can be extended.

The invention reduces the effects of a double arc.

Further features and advantages of the invention will be apparent from the appended claims and the description of several working examples that follows, with reference to the schematic drawings. The figures show:

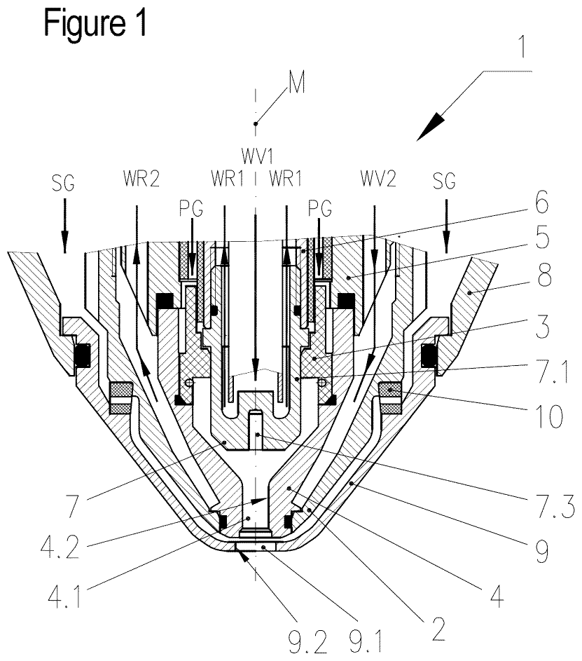

FIG. 1: a section view of a plasma torch in a particular embodiment of the present invention;

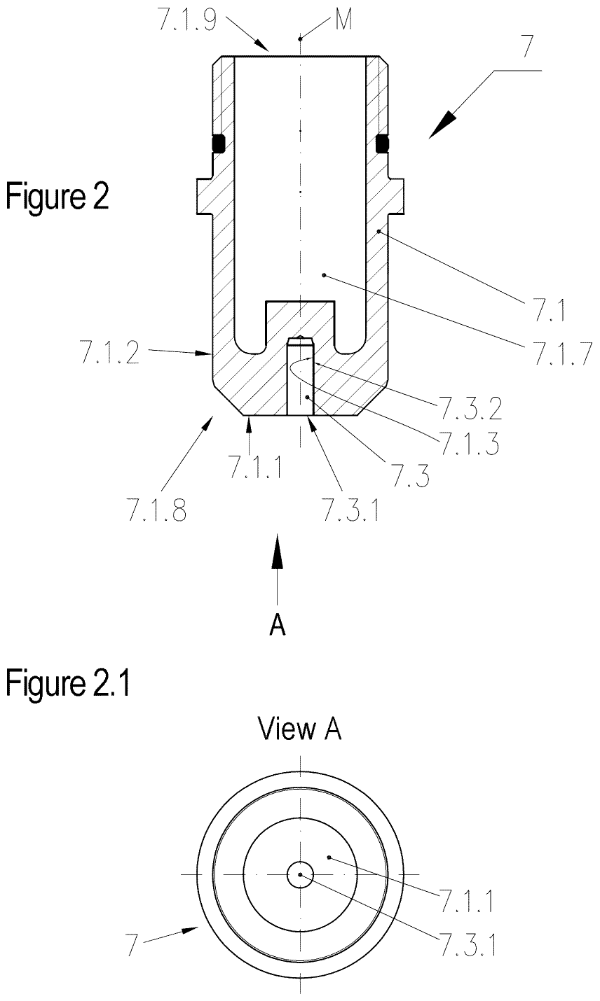

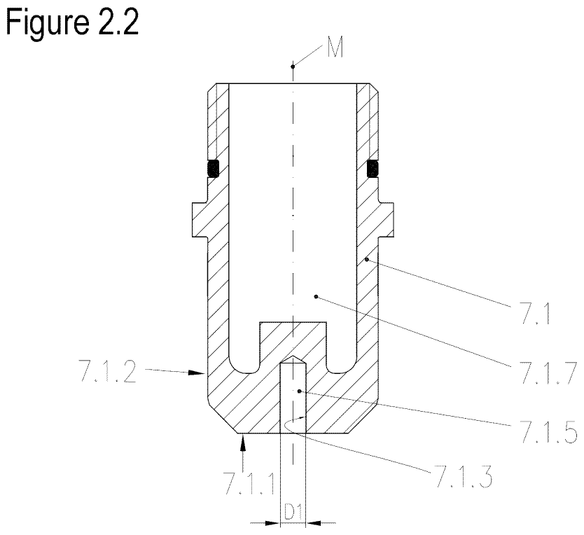

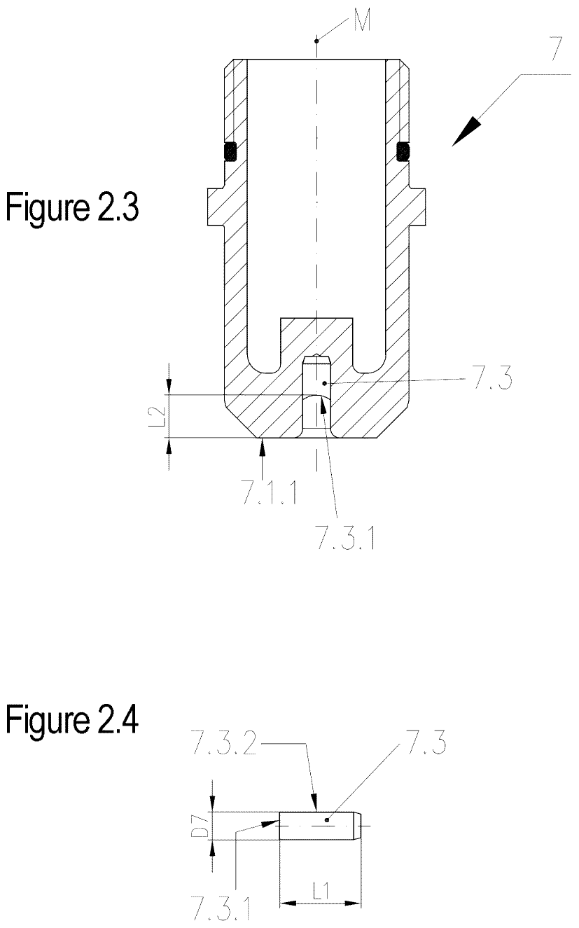

FIG. 2: a section view of an electrode of the plasma burner from FIG. 1 in a particular embodiment of the present invention;

FIG. 2.1: a front view of the electrode from FIG. 2;

FIG. 2.2: a section view of an electrode mount of the electrode from FIG. 2 in a further particular embodiment of the present invention;

FIG. 2.3: a further section view of the electrode of the plasma burner from FIG. 1;

FIG. 2.4: a section view of an emission insert of the electrode from FIG. 2 in a particular embodiment of the present invention;

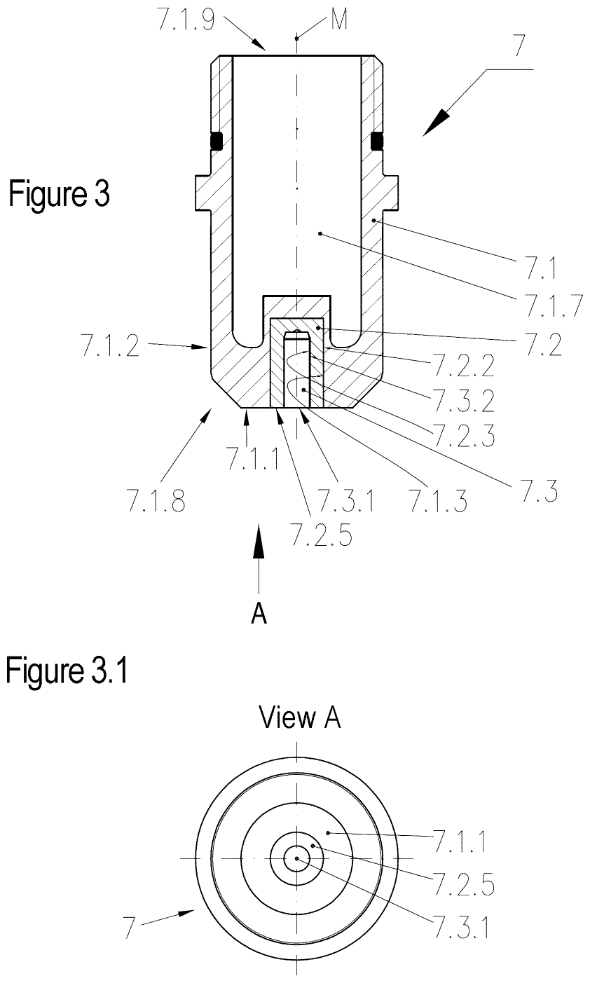

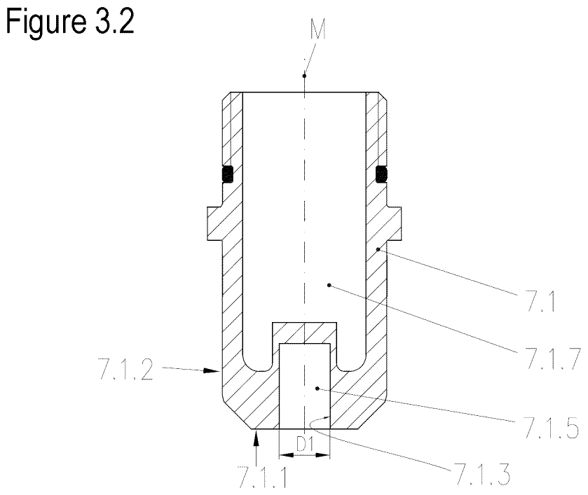

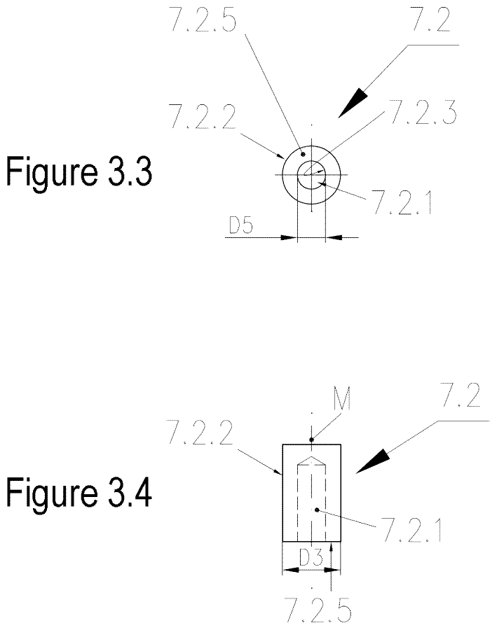

FIG. 3: a section view of an electrode in a further particular embodiment of the present invention;

FIG. 3.1: a front view of the electrode from FIG. 3;

FIG. 3.2: a section view of an electrode mount of the electrode from FIG. 3 in a particular embodiment of the present invention;

FIG. 3.3: a front view of a mount element of the electrode from FIG. 3 in a particular embodiment of the present invention;

FIG. 3.4: a side view of the mount element from FIG. 3.3;

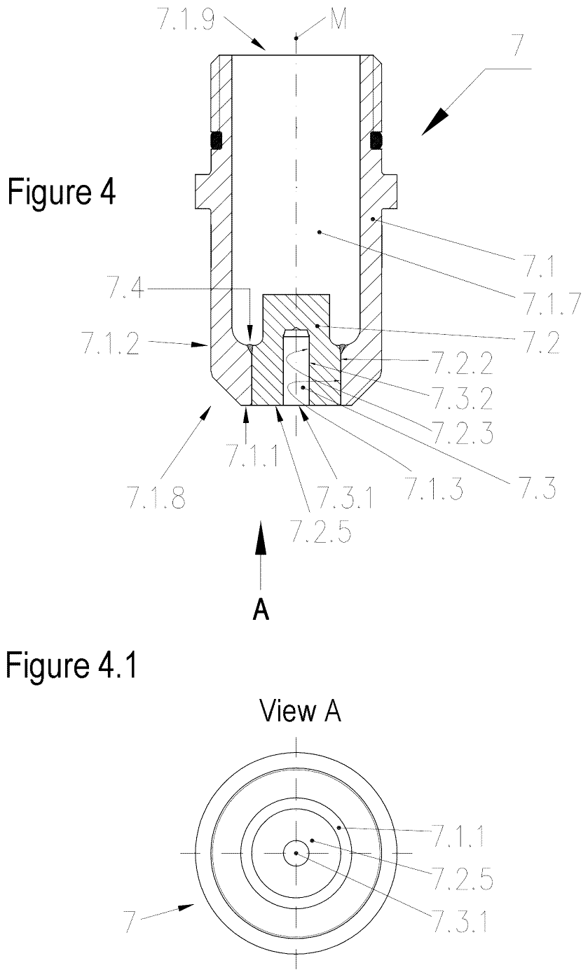

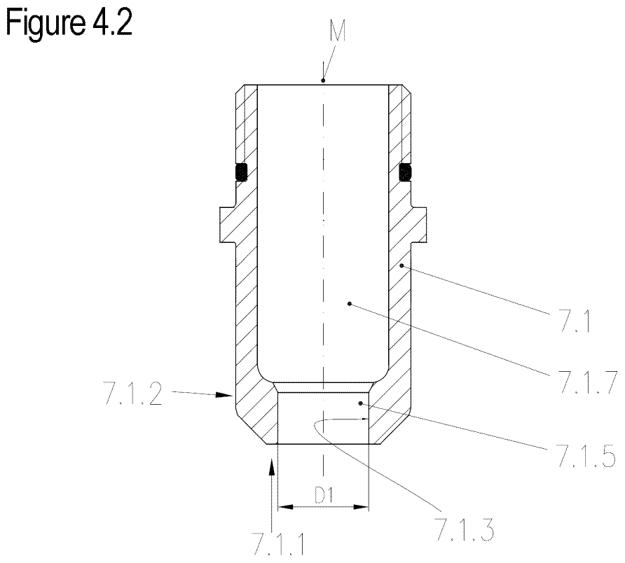

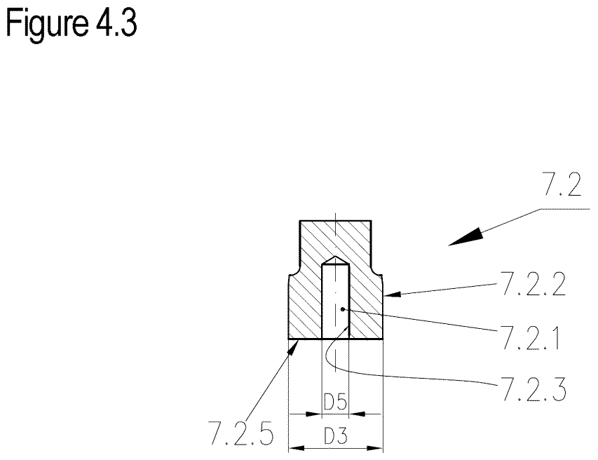

FIG. 4: a section view of an electrode in a further particular embodiment of the present invention;

FIG. 4.1: a front view of the electrode from FIG. 4;

FIG. 4.2: a section view of an electrode mount of the electrode from FIG. 4 in a particular embodiment of the present invention;

FIG. 4.3: a section view of a mount element of the electrode from FIG. 4 in a particular embodiment of the present invention;

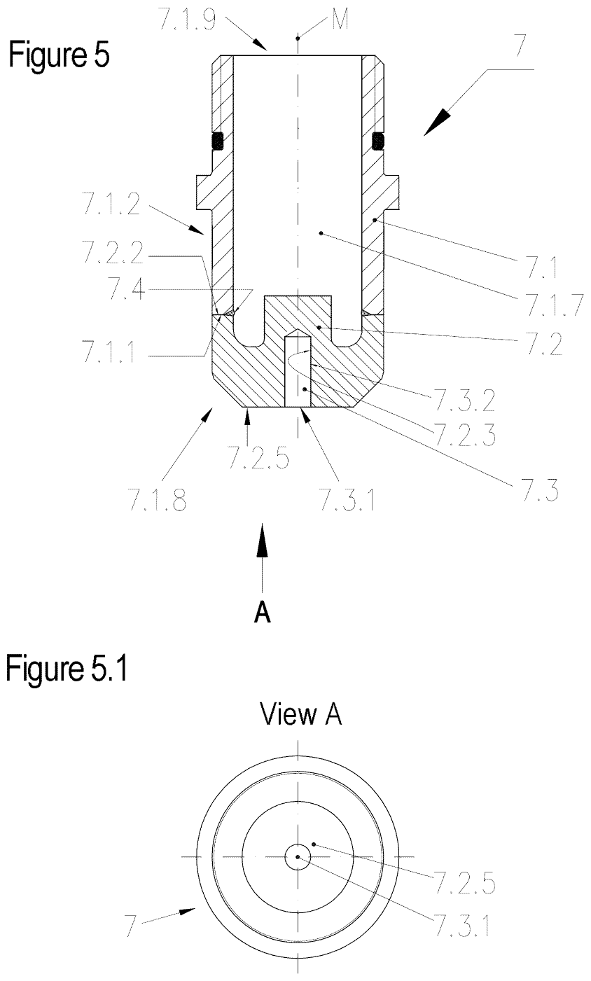

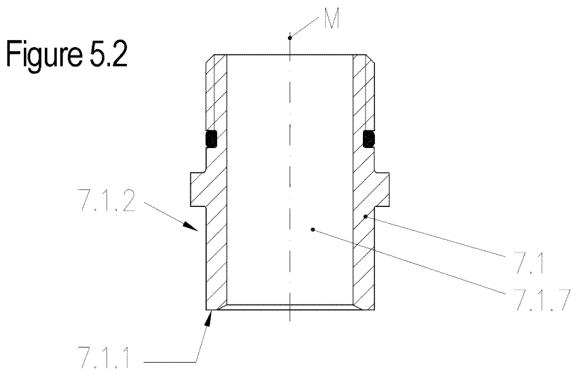

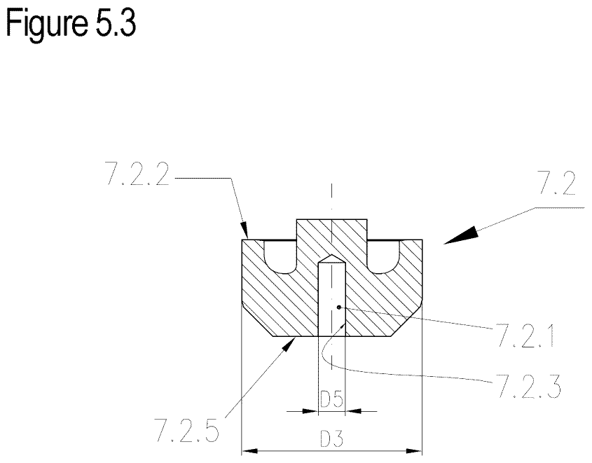

FIG. 5: a section view of an electrode in a further particular embodiment of the present invention;

FIG. 5.1: a front view of the electrode from FIG. 5;

FIG. 5.2: a section view of an electrode mount of the electrode from FIG. 5 in a particular embodiment of the present invention;

FIG. 5.3: a section view of a mount element of the electrode from FIG. 5 in a particular embodiment of the present invention;

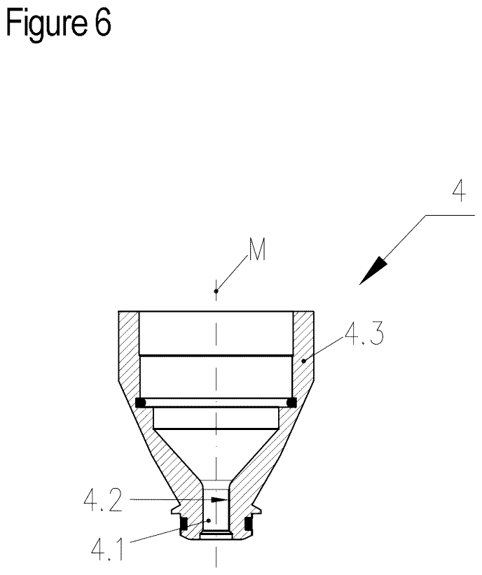

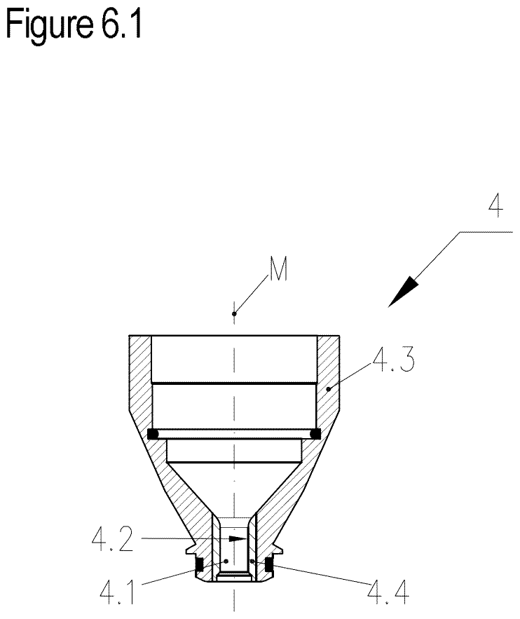

FIG. 6: a section view of a nozzle in a particular embodiment of the present invention;

FIG. 6.1: a further section view of the nozzle from FIG. 6;

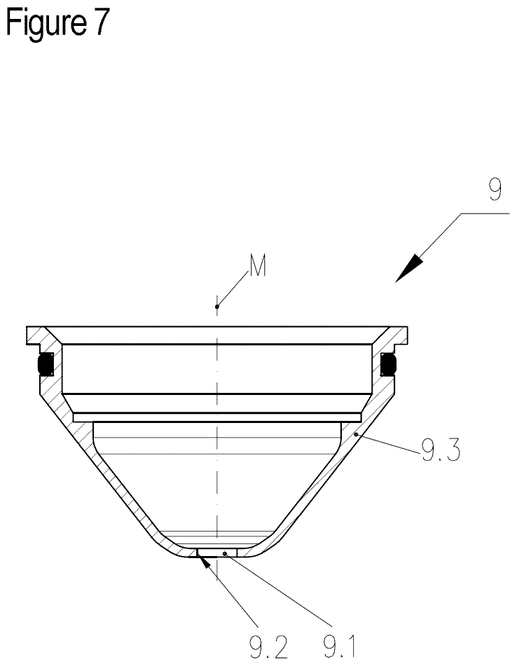

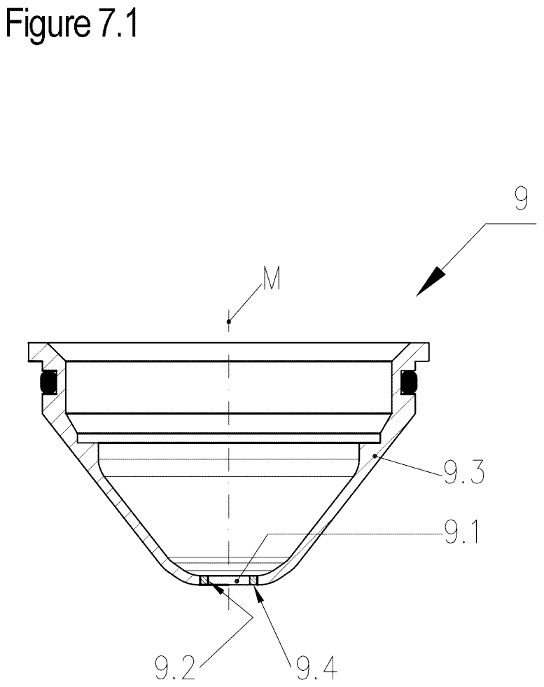

FIG. 7: a section view of a nozzle protection cap in a particular embodiment of the present invention;

FIG. 7.1: a section view of the nozzle protection cap from FIG. 7;

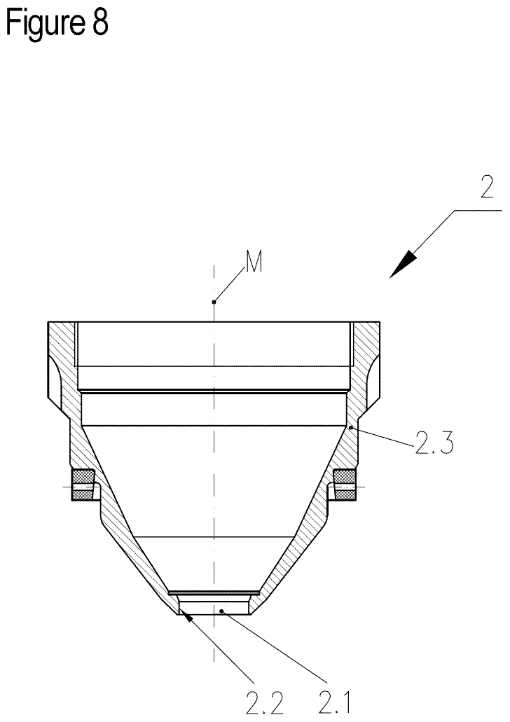

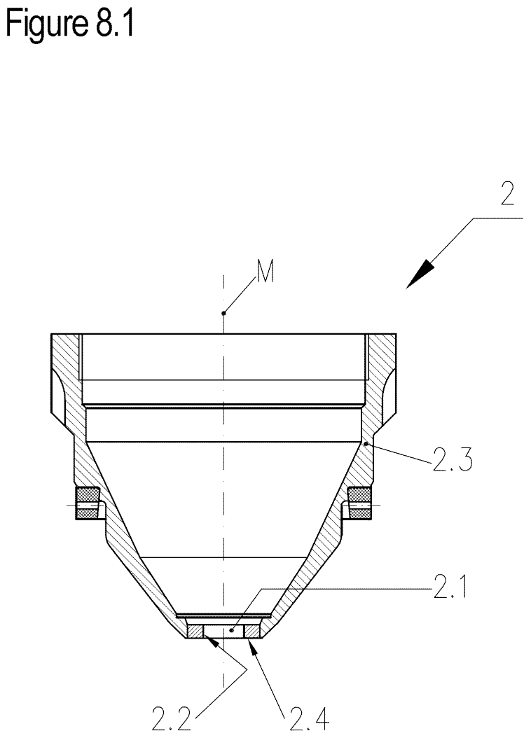

FIG. 8: a section view of a nozzle cap of the plasma burner from FIG. 1 in a particular embodiment of the present invention; and

FIG. 8.1: a section view of the nozzle cap from FIG. 8 with a nozzle cap insert in a particular embodiment of the present invention.

FIG. 1 shows a section diagram of a plasma cutting torch 1 in a particular embodiment of the present invention with a nozzle cap 2, a plasma gas guide 3, a nozzle 4 in a particular embodiment of the present invention with nozzle opening 4.1, a nozzle and nozzle cap holder 5, an electrode holder 6 and an electrode 7 in a particular embodiment of the present invention. The electrode 7 comprises an electrode mount 7.1 and an emission insert 7.3 having a length L1 of, for example, 3 mm, an outer casing 7.3.2 and a front face 7.3.1 (see FIG. 2.4). In this example, the nozzle and nozzle cap holder 5 serves as a mount for both the nozzle and the nozzle cap. In other examples, however, there may also be a nozzle holder and a nozzle cap holder separately.

The plasma cutting torch 1 further comprises a nozzle protection cap holder 8, on which a nozzle protection cap 9 is secured in a particular embodiment of the present invention with a nozzle protection cap opening 9.1. The plasma cutting torch 1 also includes a secondary gas guide 10 in this example. Secondary gas SG is fed through the secondary gas guide 10. In addition, there is a feed for plasma gas PG, coolant returns WR1 and WR2, and also coolant flows WV1 and WV2 in the plasma cutting torch 1. The arc or plasma beam burns in operation during cutting between the emission insert 7.3 of the electrode 7, and flows through and is constricted by the nozzle opening 4.1 and the nozzle cap opening 9.1 before it hits a workpiece (not shown). The inner face of the nozzle opening 4.1 is labelled 4.2, and that of the nozzle cap opening 9.1 is labelled 9.2.

FIGS. 2 and 2.1 show the electrode 7 from FIG. 1, where FIG. 2 is a section diagram through electrode 7 and FIG. 2.1 is the view A of the front end of the electrode 7. The electrode 7 has a front end 7.1.8 with a front face 7.1.1, a back end 7.1.9, an outer face 7.1.2 and a cavity 7.1.1, through which a coolant flows or can flow in the installed state. The electrode 7 comprises the electrode mount 7.1, which is shown by way of example in FIG. 2.2, and the emission insert 7.3, which is shown by way of example in FIG. 2.4. The emission insert 7.3 is pressed into a hole 7.1.5 having a diameter D1 of, for example, 1.8 mm (−0.05) of the electrode mount 7.1. The bore 7.1.5 has an inner face 7.1.3 which is in touch contact with the outer face 7.3.2 of the emission insert 7.3. The mass of the emission insert 7.3 in this example preferably consists of at least 97% of hafnium; the residual component is essentially zirconium.

The electrode mount 7.1 consists by way of example of a material composed of silver, copper and aluminum oxide Al₂O₃. For example, the proportions of the mass are distributed as follows: silver 92.5%, copper 7% and aluminum oxide Al₂O₃ 0.5%. The material for the entire electrode mount 7.1 has been used here by way of example. There is also the possibility that the material is present only in a portion or region of the electrode mount 7.1. This is then preferably the case at least at the inner face 7.1.3 of the electrode mount 7.1. This region then preferably extends radially outward by at least 0.5 mm from the inner face. It is even better when the area extends radially outward by at least 1 mm. This can be achieved, for example, in such a way that the aluminum oxide content and/or silver content is reduced radially outward, and the copper content is increased.

FIG. 2.3, which shows a sectional view of the electrode 7, also shows a burnback L2. The burnback is defined as the difference between the area 7.3.1 of the emission insert 7.3 in the new state and the lowest point of the area that was burnt back in operation. In the present example, for example, L2=2 mm.

There is also the possibility that the electrode mount is made of only one material composed of copper and aluminum oxide. A proportion by mass of 99.5% copper and 0.5% aluminum oxide is given here by way of example.

FIG. 3 shows an electrode 7 in a further particular embodiment of the invention, where FIG. 3 is a section diagram through electrode 7 and FIG. 3.1 is the view A of the front end 7.1.8 of the electrode 7. The electrode 7 has a front end 7.1.8 with a front face 7.1.1, a back end 7.1.9, an outer face 7.1.2 and a cavity 7.1.1, through which a coolant flows or can flow in the installed state. The electrode 7 comprises an electrode mount 7.1, which is shown by way of example in FIG. 3.1, a mount element 7.2, which is shown by way of example in FIG. 3.3 and 3.4, and an emission insert 7.3. The emission insert 7.3 is pressed into a hole 7.2.1 having a diameter D5 of the mount element 7.2. The bore 7.2.1 has an inner face 7.2.3 which is in touch contact with the outer face 7.3.2 of the emission insert 7.3.

The mount element 7.2 having an outer diameter D3 is pressed into the bore 7.1.5 having an internal diameter D1 of the electrode mount 7.1. The bore has an inner face 7.1.3 which is in touch contact with the outer casing 7.2.2 of the mount element.

The mount element consists here by way of example of a material composed of silver, copper and aluminum oxide. For example, the proportions of the mass are distributed as follows: silver 92.5%, copper 7% and aluminum oxide Al₂O₃ 0.5%. The material for the entire mount element 7.2 has been used here by way of example.

The mount element 7.2 has a diameter D3 of, for example, 4 mm; the emission insert 7.3 has a diameter D7 (see FIG. 2.4) of, for example, 1.8 mm. This results in a wall thickness of the mount element of 1.1 mm and hence also a front circular ring face 7.2.5 that extends radially outward by 1.1 mm.

There is also the possibility that the material is present only in a portion or region of the mount element 7.2. This is then preferably the case at least at the inner face 7.2.3 of the mount element 7.2. This region then preferably extends radially outward by at least 0.5 mm from the inner face 7.2.3. It is even better when the area extends radially outward by at least 1 mm. This can be achieved, for example, in such a way that the aluminum oxide content and/or silver content is reduced radially outward, and the copper content is increased.

The electrode mount 7.1 consists at least of a material of good electrical conductivity, in this example to an extent of 99.9% of its mass of copper.

The mass of the emission insert in this example preferably consists to an extent of at least 97% of hafnium. In this example, the residual component is essentially zirconium.

There is also the possibility that the electrode mount is made of only one material composed of copper and aluminum oxide. A proportion by mass of 99.5% copper and 0.5% aluminum oxide is given here by way of example.

FIG. 4 shows an electrode 7 in a further particular embodiment of the invention, where FIG. 4 is a section diagram through electrode 7 and FIG. 4.1 is the view A of the front end 7.1.8 of the electrode 7. The electrode 7 has a front end 7.1.8 with a front face 7.1.1, a back end 7.1.9, an outer face 7.1.2 and a cavity 7.1.1, through which a coolant flows or can flow in the installed state. The electrode 7 comprises an electrode mount 7.1 shown in FIG. 4.2, a mount element 7.2 shown in FIG. 4.3, and an emission insert 7.3. The emission insert 7.3 has been inserted into a bore 7.2.1 having a diameter D5 of the mount element 7.2.

The bore 7.2.1 of the mount element 7.2 has an inner face 7.2.3 which is in touch contact with the outer face 7.3.2 of the emission insert 7.3.

The mount element 7.2 having an outer diameter D3 is pressed into a bore 7.1.5 having an internal diameter D1 of the electrode mount 7.1. The bore 7.1.5 has an inner face 7.1.3 which is in touch contact with the outer face 7.2.2 of the mount element 7.2. The mount element 7.2 may be connected to the electrode mount 7.1, for example, by force-fitting, form-fitting, but also by a thermal joining method, such as soldering, welding, in particular laser soldering, laser welding, arc soldering, arc welding, vacuum soldering, vacuum laser welding or electron beam welding. It is particularly advantageous when welding or soldering is effected from the back end 7.1.9, and there is a seam (weld line, solder line) 7.4 in a cavity 7.1.7 extending toward the back end. Another advantageous joining method is diffusion welding, where pressure and temperature are employed.

If thermal joining, for example soldering or welding, of the mount element 7.2 to the electrode mount 7.1 is effected from the direction of the cavity 7.1.7, this has the following advantages over thermal joining from the front, for example:
no seam visible from the front and
no reworking needed.

The mount 7.2 consists here by way of example of a material composed of copper and aluminum oxide. For example, the proportions of the mass are distributed as follows: copper 99.3% and aluminum oxide 0.7%. The material for the entire mount element 7.2 has been used here by way of example.

The mount element 7.2 has a diameter D3 of, for example, 6 mm; the emission insert 7.3 has a diameter D7 of, for example, 1.8 mm. This results in a wall thickness of the mount element 7.2 of 2.1 mm and hence also a front circular ring face 7.2.5 that extends radially outward by 2.1 mm.

There is also the possibility that the material is present only in a portion or region of the mount element 7.2. This is then preferably the case at least at the inner face 7.2.3 of the mount element 7.2. This region then preferably extends radially outward by at least 0.5 mm from the inner face. It is even better when the area extends radially outward by at least 1 mm. This can be achieved, for example, in such a way that the aluminum oxide content and/or silver content is reduced radially outward, and the copper content is increased.

The electrode mount 7.1 consists at least of a material of good electrical conductivity, in this example to an extent of 99.9% of its mass of copper.

The mass of the emission insert in this example preferably consists to an extent of at least 97% of hafnium.

FIG. 5 shows an electrode 7 in a further particular embodiment, where FIG. 5 is a section diagram through electrode 7 and FIG. 5.1 is the view A of the front end 7.1.8 of the electrode. The electrode 7 has a front end 7.1.8, a back end 7.1.9, an outer face 7.1.2 and a cavity 7.1.1, through which the coolant flows or can flow in the installed state. The electrode 7 comprises an electrode mount 7.1, which is shown by way of example in FIG. 5.2, a mount element 7.2, which is shown by way of example in FIG. 5.3, and an emission insert 7.3. The emission insert 7.3 has been inserted into a bore 7.2.1 having a diameter D5 of the mount element 7.2.

The bore of the mount element 7.2 has an inner face 7.2.3 which is in touch contact with the outer face 7.3.2 of the emission insert.

The mount element 7.2 is mounted on the cylindrical section with its outer face 7.2.2 on the front face 7.1.1 of the electrode mount 7.1. The mount element 7.2 may be connected to the electrode mount 7.1, for example, by force-fitting, form-fitting, but also by a thermal joining method, such as soldering, welding, in particular laser soldering, laser welding, arc soldering, arc welding, vacuum soldering, vacuum laser welding or electron beam welding. It is particularly advantageous when welding or soldering is effected from the back end 7.19, and there is a seam (weld line, solder line) 7.4 in a cavity 7.1.7 extending toward the back end. Another advantageous joining method is diffusion welding, where pressure and temperature are employed.

The mount element 7.2 consists here by way of example of a material composed of silver, copper and aluminum oxide. For example, the proportions of the mass are distributed as follows: silver 92%, copper 7.5% and aluminum oxide 0.5% The material for the entire mount element 7.2 has been used here by way of example.

The mount element 7.2 has a diameter D3 of, for example, 10 mm; the emission insert has a diameter D7 of, for example, 1.8 mm. This results in a wall thickness of the mount element 7.2 of 4.1 mm and hence also a front circular ring face 7.2.5 that extends radially outward by 4.1 mm.

There is also the possibility that the material is present only in a portion or region of the mount element 7.2. This is then preferably the case at least at the inner face 7.2.3 of the mount element 7.2. This region then preferably extends radially outward by at least 0.5 mm from the inner face. It is even better when the area extends radially outward by at least 1 mm. This can be achieved, for example, in such a way that the aluminum oxide content and/or silver content is reduced radially outward, and the copper content is increased.

The electrode mount 7.1 consists at least of a material of good electrical conductivity, in this example to an extent of 99.5% of its mass of copper.

The mass of the emission insert in this example preferably consists at least of 97% of hafnium.

FIG. 6 shows a nozzle 4 from FIG. 1 is inserted. For example, this nozzle 4 may consist entirely of a material composed of copper and aluminum oxide. However, it is essential that the region of the nozzle that can come into contact with the plasma jet or with the arc is made of this material. This is the inner face 4.2 of the nozzle opening 4.1. This can be effected, for example, by securing a nozzle insert 4.4 made of said material in a nozzle mount 4.3. This is shown by way of example in FIG. 6.1.

In the present example according to FIG. 6, the nozzle 4 consists of a material composed of copper and aluminum oxide. For example, the proportions of the mass are distributed as follows: copper 99.7%, aluminum oxide 0.3%. The material for the entire nozzle 4 has been used here by way of example in FIG. 6.

The nozzle insert 4.4 shown in FIG. 6.1 may be connected to the nozzle mount 4.3, for example, by force-fitting, form-fitting, but also by a thermal joining method, such as soldering, welding, in particular laser soldering, laser welding, arc soldering, arc welding, vacuum soldering, vacuum laser welding or electron beam welding. Another advantageous joining method is diffusion welding, where pressure and temperature are employed.

FIG. 7 shows the nozzle protection cap 9 according to FIG. 1. This nozzle protection cap 9 may consist entirely of a material composed of copper and aluminum oxide. However, it is essential that the region of the nozzle protection cap that can come into contact with the plasma jet or with the arc is made of this material. This is the inner face 9.2 of the nozzle protection cap 9. This can be effected, for example, by securing a nozzle protection cap insert 9.4 composed of said material in a nozzle protection cap mount 9.3. This is shown by way of example in FIG. 7.1.

In the present example according to FIG. 7, the nozzle protection cap 9 consists of a material composed of copper and aluminum oxide. For example, the proportions of the mass are distributed as follows: copper 99.5%, aluminum oxide 0.5%. The material for the entire nozzle protection cap 9 has been used here by way of example.

The nozzle protection cap insert 9.4 shown in FIG. 7.1 may be connected to the nozzle protection cap mount 9.3, for example, by force-fitting, form-fitting, but also by a thermal joining method, such as soldering, welding, in particular laser soldering, laser welding, arc soldering, arc welding, vacuum soldering, vacuum laser welding or electron beam welding. Another advantageous joining method is diffusion welding, where pressure and temperature are employed.

FIG. 8 shows the nozzle cap 2 of the plasma torch according to FIG. 1. This nozzle cap 2 may consist entirely of a material composed of copper and aluminum oxide. However, it is essential that the region of the nozzle cap that can come into contact with the plasma jet or with the arc is made of this material. This is the inner face 2.2 of the nozzle cap 2. This can be effected, for example, by securing a nozzle cap insert 2.4 made of said material in a nozzle protection cap mount 2.3. This is shown by way of example in FIG. 8.1.

In the present example according to FIG. 8, the nozzle cap 2 consists of a material composed of copper and aluminum oxide. For example, the proportions of the mass are distributed as follows: copper 99.5%, aluminum oxide 0.5%. The material for the entire nozzle protection cap 2 has been used here by way of example.

The nozzle cap insert 2.4 shown in FIG. 8.1 may be connected to the nozzle protection cap mount 2.3, for example, by force-fitting, form-fitting, but also by a thermal joining method, such as soldering, welding, in particular laser soldering, laser welding, arc soldering, arc welding, vacuum soldering, vacuum laser welding or electron beam welding. Another advantageous joining method is diffusion welding, where pressure and temperature are employed.

In the description above, the wording “in one embodiment” or “in a particular embodiment” was utilized. This may be the same embodiment or else a further or different embodiment.

The features of the invention that are disclosed in the above description, in the drawings and in the claims may be essential for the implementation of the invention in its various embodiments both individually and in any desired combinations.

### LIST OF REFERENCE SIGNS

1 arc torch

2 nozzle cap

2.1 nozzle cap opening

2.2 inner face of the nozzle cap opening

2.3 nozzle cap mount

2.4 nozzle cap insert

3 plasma gas guide

4 nozzle

4.1 nozzle opening

4.2 inner face of the nozzle opening

4.3 nozzle mount

4.4 nozzle insert

5 nozzle and nozzle cap holder

6 electrode holder

7 electrode

7.1 electrode mount

7.1.1 front face

7.1.2 outer face

7.1.3 inner face

7.1.5 bore

7.1.7 cavity

7.1.8 front end

7.1.9 back end

7.2 mount element

7.2.1 bore

7.2.2 outer casing

7.2.3 inner face

7.2.5 front circular ring face

7.3 emission insert

7.3.1 front face

7.3.2 outer casing

7.4 seam

8 nozzle protection cap holder

9 nozzle protection cap

9.1 nozzle protection cap opening

9.2 inner face of the nozzle protection cap opening

9.3 nozzle protection cap mount

9.4 nozzle protection cap insert

10 secondary gas guide

D1 internal diameter

D3 external diameter

D5 internal diameter

D7 diameter

L1 length

L2 backburn

M middle longitudinal axis

PG plasma gas

SG secondary gas

WR1 coolant return

WR2 coolant return

WV1 coolant feed

WV2 coolant feed

1. A component for an electrically operated arc torch comprising:
the component or at least part or a region of the component consists of a material comprising aluminum oxide and at least one of the chemical elements silver and copper.

2. The component of claim 1, wherein the proportion of silver or of copper or the sum total of copper and silver is one of at least 98%, at least 99%, and at least 99.5%, of the volume or mass of said material.

3. The component of claim 1, wherein the proportion of aluminum oxide is one of not less than 0.15%, not less than 0.3%, and not less than 0.5%, of the volume or mass of said material.

4. The component of claim 1, wherein the proportion of aluminum oxide in said material is one of not more than 2.0%, not more than 1.5%, and not more than 1.0%, of the volume or mass of said material.

5. The component of claim 1, wherein the component is a wearing part for an arc torch.

6. The component of claim 5, wherein said wearing part is an electrode for an arc torch.

7. The component of claim 6, wherein said electrode has a front end and a back end, extends along a longitudinal axis M, and has at least one emission insert at said front end and an electrode mount or a mount element for said emission insert.

8. The component of claim 7, wherein at least a portion of an inner face of said electrode mount or an inner face of said mount element which is in touch contact with said emission insert consists of said material.

9. The component of claim 8, wherein said material extends radially outward by one of at least 0.5 mm, at least 1 mm, and at least 1.3 mm at least from said portion of said inner face of said electrode mount or said inner face of said mount element.

10. The component of claim 7, wherein at least a portion of a front face that is directly adjacent to a front face of said emission insert includes said material.

11. The component of claim 10, wherein said portion of said front face extends radially outward by one of at least 0.5 mm, at least 1 mm, and at least 1.3 mm.

12. The component of claim 7, wherein said emission insert consists of at least 90% by volume or mass of one of hafnium, zirconium, and tungsten.

13. The component of claim 5, wherein said wearing part is a nozzle having at least one nozzle opening.

14. The component of claim 13, wherein at least a portion of an inner face of said nozzle opening includes said material.

15. The component of claim 14, wherein said material extends radially outward at least from said portion of said inner face of said nozzle opening by one of at least 0.5 mm, at least 1 mm, and at least 1.3 mm.

16. The component of claim 5, wherein said wearing part is a nozzle protection cap having at least one nozzle protection cap opening.

17. The component of claim 16, wherein at least a portion of an inner face of said nozzle protection cap opening includes said material.

18. The component of claim 17, wherein said material extends radially outward at least from said portion of said inner surface of said nozzle protection cap opening one of at least 0.5 mm, at least 1 mm, and at least 1.3 mm.

19. The component of claim 5, wherein said wearing part is a nozzle cap having at least one nozzle cap opening.

20. The component of claim 19, wherein at least a portion of an inner face of said nozzle cap opening includes said material.

21. The component of claim 20, wherein said material extends radially outward at least from said portion of said inner face of said nozzle cap opening by one of at least 0.5 mm, at least 1 mm, and at least 1.3 mm.

22. The component of claim 1, wherein the component is a holder or a mount for at least one wearing part for an arc torch.

23. The component of claim 22, wherein said holder or said mount is a nozzle holder, a nozzle cap holder, an electrode holder, or a nozzle protection cap holder.

24. An arc torch comprising:
a component wherein said component or at least part or a region of said component consists of a material comprising aluminum oxide and at least one of the chemical elements silver and copper.

25. The arc torch of claim 24, wherein the arc torch is a plasma torch or plasma cutting torch.

26. A method of plasma cutting using an arc torch wherein the arc torch is a plasma torch or plasma cutting torch that comprises at least one component wherein the component or at least part or a region of the component consists of a material comprising aluminum oxide and at least one of the chemical elements silver and copper, wherein the plasma cutting torch is operated with oxygen, an oxygen-containing gas or gas mixture and/or reducing gas or gas mixture and/or inert gas or gas mixture as plasma gas (PG) and/or secondary gas (SG).

27. The method of plasma cutting using an arc torch wherein the arc torch is a plasma torch or plasma cutting torch that comprises at least one component wherein the component or at least part or a region of the component consists of a material comprising aluminum oxide and at least one of the chemical elements silver and copper, wherein the plasma cutting torch is operated with oxygen or an acidic gas mixture in which the proportion of oxygen is at least 25 per cent by volume of the gas mixture as plasma gas (PG) and/or secondary gas (SG).

28. The method of plasma cutting using a plasma cutting torch wherein the arc torch is a plasma torch or plasma cutting torch that comprises at least one component wherein the component or at least part or a region of the component consists of a material comprising aluminum oxide and at least one of the chemical elements silver and copper, wherein the plasma cutting torch is operated with argon or an argon-containing gas mixture in which the proportion of the argon is at least 25 percent by volume of the gas mixture as plasma gas (PG) and/or secondary gas (SG).

29. The method of claim 26, wherein the at least one component or at least one of the components is cooled with a liquid medium.

30. The method of claim 27, wherein the at least one component or at least one of the components is cooled with a liquid medium.

31. The method of claim 28, wherein the at least one component or at least one of the components is cooled with a liquid medium.

32. The arc torch of claim 24, wherein the proportion of silver or of copper or the sum total of copper and silver is one of at least 98%, at least 99%, and at least 99.5%, of the volume or mass of said material.

33. The arc torch of claim 24, wherein the proportion of aluminum oxide is one of not less than 0.15%, not less than 0.3%, and not less than 0.5%, of the volume or mass of said material.

34. The arc torch of claim 24, wherein the proportion of aluminum oxide in said material is one of not more than 2.0%, not more than 1.5%, and not more than 1.0%, of the volume or mass of said material.

35. The arc torch of claim 24, wherein the component is a wearing part for the arc torch.

36. The arc torch of claim 35, wherein said wearing part is an electrode.

37. The arc torch of claim 36, wherein said electrode has a front end and a back end, extends along a longitudinal axis M, and has at least one emission insert at said front end and an electrode mount or a mount element for said emission insert.

38. The arc torch of claim 37, wherein at least a portion of an inner face of said electrode mount or an inner face of said mount element which is in touch contact with said emission insert consists of said material.

39. The arc torch of claim 38, wherein said material extends radially outward by one of at least 0.5 mm, at least 1 mm, and at least 1.3 mm at least from said portion of said inner face of said electrode mount or said inner face of said mount element.

40. The arc torch of claim 37, wherein at least a portion of a front face that is directly adjacent to a front face of said emission insert includes said material.

41. The arc torch of claim 40, wherein said portion of said front face extends radially outward by one of at least 0.5 mm, at least 1 mm, and at least 1.3 mm.

42. The arc torch of claim 47, wherein said emission insert consists of at least 90% by volume or mass of one of hafnium, zirconium, and tungsten.

43. The arc torch of claim 36, wherein said wearing part is a nozzle having at least one nozzle opening.

44. The arc torch of claim 43, wherein at least a portion of an inner face of said nozzle opening includes said material.

45. The arc torch of claim 44, wherein said material extends radially outward at least from said portion of said inner face of said nozzle opening by one of at least 0.5 mm, at least 1 mm, and at least 1.3 mm.

46. The arc torch of claim 36, wherein said wearing part is a nozzle protection cap having at least one nozzle protection cap opening.

47. The arc torch of claim 46, wherein at least a portion of an inner face of said nozzle protection cap opening includes said material.

48. The arc torch of claim 47, wherein said material extends radially outward at least from said portion of said inner surface of said nozzle protection cap opening one of at least 0.5 mm, at least 1 mm, and at least 1.3 mm.

49. The arc torch of claim 36, wherein said wearing part is a nozzle cap having at least one nozzle cap opening.

50. The arc torch of claim 49, wherein at least a portion of an inner face of said nozzle cap opening includes said material.

51. The arc torch of claim 50, wherein said material extends radially outward at least from said portion of said inner face of said nozzle cap opening by one of at least 0.5 mm, at least 1 mm, and at least 1.3 mm.

52. The arc torch of claim 24, wherein the component is a holder or a mount for at least one wearing part for an arc torch.

53. The arc torch of claim 52, wherein said holder or said mount is a nozzle holder, a nozzle cap holder, an electrode holder, or a nozzle protection cap holder.
